(19) United States
(12) Patent Application Publication
(10) Pub. No.: US 2001/0027667 A1
(43) Pub. Date: Oct. 11, 2001

(54) Heavy-duty slam-to-close rotary ratchet pull latch

(76) Inventors: Christopher J. Pinkow, Boothwyn, PA (US); Robert Straka, Phoenixville, PA (US)

Correspondence Address: Mohammad S. Rahman, Esq., PAUL & PAUL, 2900 Two Thousand Market Street, Philadelphia, PA, 19103, US

(21) Appl. No.: 09/782,907

(22) Filed: Feb. 14, 2001

Related U.S. Application Data
(60) Provisional application No. 60/182,271, filed on Feb. 14, 2000.
(60) Provisional application No. 60/221,023, filed on Jul. 27, 2000.

(51) Int. Cl. F16C 3/00

(52) U.S. Cl. 70/208

(57) ABSTRACT

A rotary-action heavy-duty slam-to-close latch for closing a panel or door and securing the same, wherein actuation means articulates a sliding locking member into and out of engagement with a lock plate, thereby moving the lock plate from a closed position to an open position, thereby releasing a pawl into and out of latching positions with a corresponding keeper. Several embodiments of actuation means are provided such as a rotatably mounted handle, a motor-driven cam assembly, and a rod-driven handle assembly.

### CROSS REFERENCE TO RELATED APPLICATIONS

This application claims the benefit of U.S. Provisional Patent Application No. 60/182,271, Filed Feb. 14, 2000; and U.S. Provisional Patent Application No. 60/221,023, Filed Jul. 27, 2000.

### BACKGROUND OF THE INVENTION

1. Field of the invention

The present invention relates generally to latching devices and more particularly to a handle for securing a first member, such as a door, panel, or a similar closure member in a closed position relative to a second member, such as a corresponding door, panel, or similar closure member.

2. Brief Description of the Prior Art

Slam-action latches are known in the art and are employed in a number of applications. Generally, latches coming within this category operate by forcing a pawl into engagement with a keeper. For example, where a first panel member has a pawl and a second panel member, such as, for example, a cabinet, has a keeper thereon, slamming shut the first panel member against the second panel member secures the panels.

In many cases, doors of vehicles, particularly those associated with the back open-end of a pickup truck need to be secured so that when the vehicle is operating, the door will not become detached. A loose or detached door can cause the contents of the pick-up truck bed to escape and further can damage to the truck bed lining if repeated slamming of the door occurs. A latch is needed which will secure the pickup truck back-end cover securely, and which can be readily actuated to release the door to thereby provide access to the in the pickup truck bed.

### SUMMARY OF THE INVENTION

The present invention involves a rotary-action heavy-duty slam latch with several embodiments and with multiple actuation methods. These different actuation methods are a representation of the versatility of the design, such that this design can be used as a single- or multi-point latching application. Regardless of the actuation method, all of designs use the same latching concept.

One application for the latch is for tonneau covers for pick-up trucks. The tonneau cover encloses the back open end of a pick-up truck and includes one or more covers in order to gain access to the interior of the pick-up bed. As will be described in more detail herein, the latch can be used to secure the respective covers to the tonneau cover and/or truck bed when the cover is in a closed position. In this application, preferably the latch is mounted on the inside surface of the tonneau cover or truck bed so that the latch is not visible from the outside. For operation, access to the interior of the truck bed is required to actuate the latch, which preferably is accomplished by raising the tailgate cover. The latch is subsequently operated for latching.

In its first embodiment, the latch design comprises of seven major components: one pawl (double-sided), one latch frame, one lock plate, two rivets, and two torsion springs. The pawl is connected to the frame by a rivet. The pawl is double-sided, which puts the pawl and rivet into double shear for strength purposes. This rivet also serves as the pivot point for the pawl and the guide for the torsion spring that keeps the pawl in the open position. Similarly, the lock plate is also connected to the frame by a rivet. This rivet serves the same purpose as the pawl rivet except that the torsion spring keeps the lock plate in the locked position. When the keeper, represented by a U-shaped wire on the drawings, comes in contact with the open pawl, the pawl will rotate until it reaches the closed position. Once the pawl is in the closed position, the lock plate will engage with a groove in the pawl and frame. When the lock plate is disengaged from the pawl, the pawl will spring into the open position and release the keeper.

The first three drawings show the pawl and two rivets that are common to all three actuation methods. The first actuation method can be used in applications where the latching point must be located at the point of actuation. To operate, the user must pull the handle. If the lockplug is in the open position, then a plate will pull the lock plate and open the latch. By 11 turning a key into the locked position, the lockplug will slide the plate so that the plate will not come in contact with the lock plate if the handle is pulled.

The second actuation method shown uses an electric motor and cam assembly to drive the lock plate and open the latch. This application can be used in single- or multi-point actuation where a single key-operated switch or a remote keyless transmitter will briefly power the electric motor(s).

The third actuation method is also for single- or multi-point actuation, but the actuation is mechanically driver either by rod or cable. The latch is opened by pulling on the handle, which rotates about a pivot point. As the handle rotates, a rod or cable will pull the lock plate open.

In its fourth embodiment, the latch design, otherwise referred to as a rotary ratchet pull latch, comprises of eleven major components: one pawl, one latch base, one handle, one rotary lock plate, one sliding lock member, one lock plug, one rivet, one pin, and three torsion springs. The pawl is connected to the latch base by a rivet. This rivet also serves as the pivot point for the pawl and the guide for a torsion spring that keeps the pawl in the open position. A handle houses the sliding lock member, which articulates from the lock to the unlocked position by the corresponding articulation of the lock plug, which is similarly housed in the handle. A pair of torsion springs is also secured on the handle, one on each side, to allow resistive force for the handle and the rotary lock plate.

The rotary lock plate is rotatably connected to the handle by a pin. This pin serves a similar purpose as the pawl rivet except that one of the torsion springs attached to the handle is rotatably mounted around the pin and keeps the lock plate in the locked position. When a keeper comes in contact with the open pawl, the pawl will rotate until it reaches the closed position. Once the pawl is in the closed position, the lock plate will engage with a groove in the pawl. When the lock plate is disengaged from the pawl, the pawl will spring into the open position and release the keeper. The sliding lock member allows for the locking and unlocking of the lock plate, which therefore, allows for the locking and unlocking of the latch.

An object of the present invention is to provide a novel latch of the type capable of being spring loaded.

Still another object of the present invention is to provide a latch in which the handle is rotatably attached to the latch so as to allow ease of operation.

A further object of the invention is to provide a latch which can be used for securing members in a truck bed.

These and other objects of the present invention will become more readily apparent when taken into consideration with the following description and the attached drawings.

### BRIEF DESCRIPTION OF THE DRAWINGS

FIG. 1 is a perspective view of a first embodiment of a heavy-duty slam-to-close latch in accordance with the present invention shown in an open or unlocked position.

FIG. 2 is a perspective view of a first embodiment of a heavy-duty slam-to-close latch in accordance with the present invention shown in the ½ locked position.

FIG. 3 is a perspective view of a first embodiment of a heavy-duty slam-to-close latch in accordance with the present invention shown in the ¾ locked position.

FIG. 4 is a perspective view of a first embodiment of a heavy-duty slam-to-close latch in accordance with the present invention shown in the fully locked position.

FIG. 5 is a perspective view of a first embodiment of a heavy-duty slam-to-close latch in accordance with the present invention shown in the fully locked position with full actuation of the handle.

FIG. 6 is a perspective view of a pawl in accordance with the present invention.

FIG. 7 is a top plan view of the pawl of FIG. 6.

FIG. 8 is a left side elevational view of the pawl of FIG. 6.

FIG. 9 is a front elevational view of the pawl of FIG. 6.

FIG. 10 is a right side elevational view of the pawl of FIG. 6.

FIG. 11 is a bottom plan view of the pawl of FIG. 6.

FIG. 12 is a perspective view of a first rivet in accordance with the present invention.

FIG. 13 is a top plan view of the first rivet of FIG. 12.

FIG. 14 is a front elevational view of the first rivet of FIG. 12.

FIG. 15 is a bottom plan view of the first rivet of FIG. 12.

FIG. 16 is a perspective view of a second rivet in accordance with the present invention.

FIG. 17 is a top plan view of the second rivet of FIG. 16.

FIG. 18 is a front elevational view of the second rivet of FIG. 16.

FIG. 19 is a bottom plan view of the second rivet of FIG. 16.

FIG. 20 is a perspective view of a pin in accordance with the present invention.

FIG. 21 is a top plan view of the pin of FIG. 20.

FIG. 22 is a front elevational view of the pin of FIG. 21.

FIG. 23 is a bottom plan view of the pin of FIG. 20.

FIG. 24 is a perspective view of a latch frame in accordance with the first embodiment of the present invention.

FIG. 25 is a top plan view of the latch frame of FIG. 24.

FIG. 26 is a front elevational view of the latch frame of FIG. 24.

FIG. 27 is a left side elevational view of the latch frame of FIG. 24.

FIG. 28 is a bottom plan view of the latch frame of FIG. 24.

FIG. 29 is a right side elevational view of the latch frame of FIG. 24.

FIG. 30 is a rear elevational view of the latch frame of FIG. 24.

FIG. 31 is a perspective view of a lock plate in accordance with the first embodiment of the present invention.

FIG. 32 is a top plan view of the lock plate of FIG. 31.

FIG. 33 is a front elevational view of the lock plate of FIG. 31.

FIG. 34 is a left side elevational view of the lock plate of FIG. 31.

FIG. 35 is a bottom plan view of the lock plate of FIG. 31.

FIG. 36 is a right side elevational view of the lock plate of FIG. 31.

FIG. 37 is a rear elevational view of the lock plate of FIG. 31.

FIG. 38 is a perspective view of a sliding lock member in accordance with the present invention.

FIG. 39 is a top plan view of the sliding lock member of FIG. 38.

FIG. 40 is a front elevational view of the sliding lock member of FIG. 38.

FIG. 41 is a left side elevational view of the sliding lock member of FIG. 38.

FIG. 42 is a bottom plan view of the sliding lock member of FIG. 38,

FIG. 43 is a right side elevational view of the sliding lock member of FIG. 38.

FIG. 44 is a rear elevational view of the sliding lock member of FIG. 38.

FIG. 45 is a perspective view of a lock plug in accordance with the present invention.

FIG. 46 is a top plan view of the lock plug of FIG. 45.

FIG. 47 is a front elevational view of the lock plug of FIG. 45.

FIG. 48 is a left side elevational view of the lock plug of FIG. 45.

FIG. 49 is a bottom plan view of the lock plug of FIG. 45.

FIG. 50 is a right side elevational view of the lock plug of FIG. 45.

FIG. 51 is a rear inverted elevational view of the lock plug of FIG. 45 .

FIG. 52 is a perspective view of a handle in accordance with the first embodiment of the present invention.

FIG. 53 is a top plan view of the handle of FIG. 52.

FIG. 54 is a front elevational view of the handle of FIG. 52.

FIG. 55 is a left side elevational view of the handle of FIG. 52.

FIG. 56 is a bottom plan view of the handle of FIG. 52.

FIG. 57 is a right side elevational view of the handle of FIG. 52.

FIG. 58 is a rear elevational view of the handle of FIG. 52.

FIG. 59 is a perspective view of a second embodiment of a heavy-duty slam-to-close latch in accordance with the present invention shown in the fully locked position.

FIG. 60 is a right side elevational view of the second embodiment of the heavy-duty slam-to-close latch in accordance with the present invention shown in the fully locked position.

FIG. 61 is a top plan view of the second embodiment of the heavy-duty slam-to-close latch in accordance with the present invention shown in the fully locked position.

FIG. 62 is a front elevational view of the second embodiment of the heavy-duty slam-to-close latch in accordance with the present invention shown in the fully locked position.

FIG. 63 is a bottom plan view of the second embodiment of the heavy-duty slam-to-close latch in accordance with the present invention shown in the fully locked position.

FIG. 64 is a left side elevational view of the second embodiment of the heavy-duty slam-to-close latch in accordance with the present invention shown in the fully locked position.

FIG. 65 is a perspective view of a second embodiment of a heavy-duty slam-to-close latch in accordance with the present invention shown in an open or unlocked position.

FIG. 66 is a right side elevational view of the second embodiment of the heavy-duty slam-to-close latch in accordance with the present invention shown in an open or unlocked position.

FIG. 67 is a top plan view of the second embodiment of the heavy-duty slam-to-close latch in accordance with the present invention shown in an open or unlocked position.

FIG. 68 is a front elevational view of the second embodiment of the heavy-duty slam-to-close latch in accordance with the present invention shown in an open or unlocked position.

FIG. 69 is a bottom plan view of the second embodiment of the heavy-duty slam-to-close latch in accordance with the present invention shown in an open or unlocked position.

FIG. 70 is a left side elevational view of the second embodiment of the heavy-duty slam-to-close latch in accordance with the present invention shown in an open or unlocked position.

FIG. 71 is a perspective view of a latch frame in accordance with the second embodiment of the present invention.

FIG. 72 is a top plan view of the latch frame of FIG. 71.

FIG. 73 is a left side elevational view of the latch frame of FIG. 71.

FIG. 74 is a front elevational view of the latch frame of FIG. 71.

FIG. 75 is a right side elevational view of the latch frame of FIG. 71.

FIG. 76 is a bottom plan view of the latch frame of FIG. 71.

FIG. 77 is a perspective view of a motor housing in accordance with the second embodiment of the present invention.

FIG. 78 is a front elevational view of the motor housing of FIG. 77.

FIG. 79 is a top plan view of the motor housing of FIG. 77.

FIG. 80 is a side elevational view of the motor housing of FIG. 77.

FIG. 81 is a bottom plan view of the motor housing of FIG. 77.

FIG. 82 is a rear elevational view of the motor housing of FIG. 77.

FIG. 83 is a perspective view of a lock plate in accordance with the second embodiment of the present invention.

FIG. 84 is a top plan view of the lock plate of FIG. 83.

FIG. 85 is a left side elevational view of the lock plate of FIG. 83.

FIG. 86 is a front elevational view of the lock plate of FIG. 83.

FIG. 87 is a right side elevational view of the lock plate of FIG. 83.

FIG. 88 is a bottom plan view of the lock plate of FIG. 83.

FIG. 89 is a perspective view of a cam in accordance with the second embodiment of the present invention.

FIG. 90 is a top plan view of the cam of FIG. 89.

FIG. 91 is a left side elevational view of the cam of FIG. 89.

FIG. 92 is a front elevational view of the cam of FIG. 89.

FIG. 93 is a right side elevational view of the cam of FIG. 89.

FIG. 94 is a bottom plan view of the cam of FIG. 89.

FIG. 95 is a perspective view of a third embodiment of a heavy-duty slam-to-close latch in accordance with the present invention shown in an open or unlocked position, and shown with actuation of the handle.

FIG. 96 is a perspective view of a third embodiment of a heavy-duty slam-to-close latch in accordance with the present invention shown in an open or unlocked position, and shown with no actuation of the handle.

FIG. 97 is a perspective view of a third embodiment of a heavy-duty slam-to-close latch in accordance with the present invention shown in the ¼ locked position.

FIG. 98 is a perspective view of a third embodiment of a heavy-duty slam-to-close latch in accordance with the present invention shown in the ½ locked position.

FIG. 99 is a perspective view of a third embodiment of a heavy-duty slam-to-close latch in accordance with the present invention shown in the ¾ locked position.

FIG. 100 is a perspective view of a third embodiment of a heavy-duty slam-to-close latch in accordance with the present invention shown in the fully locked position.

FIG. 101 is an alternate perspective view of the third embodiment of a heavy-duty slam-to-close latch in accordance with the present invention shown in the fully locked position.

FIG. 102 is a rear elevational view of the third embodiment of a heavy-duty slam-to-close latch of FIG. 101.

FIG. 103 is a right side elevational view of the third embodiment of a heavy-duty slam-to-close latch of FIG. 101.

FIG. 104 is a top plan view of the third embodiment of a heavy-duty slam-to-close latch of FIG. 101.

FIG. 105 is a front elevational view of the third embodiment of a heavy-duty slam-to-close latch of FIG. 101.

FIG. 106 is a bottom plan view of the third embodiment of a heavy-duty slam-to-close latch of FIG. 101.

FIG. 107 is a left side elevational view of the third embodiment of a heavy-duty slam-to-close latch of FIG. 101.

FIG. 108 is a perspective view of a latch frame in accordance with the third embodiment of the present invention.

FIG. 109 is a top plan view of the latch frame of FIG. 108.

FIG. 110 is a front elevational view of the latch frame of FIG. 108.

FIG. 111 is a left side elevational view of the latch frame of FIG. 108.

FIG. 112 is a bottom plan view of the latch frame of FIG. 108.

FIG. 113 is a right side elevational view of the latch frame of FIG. 108.

FIG. 114 is a rear elevational view of the latch frame of FIG. 108.

FIG. 115 is a perspective view of a lock plate in accordance with the third embodiment of the present invention.

FIG. 116 is a top plan view of the lock plate of FIG. 115.

FIG. 117 is a front elevational view of the lock plate of FIG. 115.

FIG. 118 is a left side elevational view of the lock plate of FIG. 115.

FIG. 119 is a bottom plan view of the lock plate of FIG. 115.

FIG. 120 is a right side elevational view of the lock plate of FIG. 115.

FIG. 121 is a rear elevational view of the lock plate of FIG. 115.

FIG. 122 is a perspective view of a handle in accordance with the third embodiment of the present invention.

FIG. 123 is a rear elevational view of the handle of FIG. 122.

FIG. 124 is a right side elevational view of the handle of FIG. 122.

FIG. 125 is a top plan view of the handle of FIG. 122.

FIG. 126 is a front elevational view of the handle of FIG. 122.

FIG. 127 is a bottom plan view of the handle of FIG. 122.

FIG. 128 is a left side elevational view of the handle of FIG. 122.

FIG. 129 is a perspective view of a linking rod in accordance with the third embodiment of the present invention.

FIG. 130 is a front elevational view of the linking rod of FIG. 129.

FIG. 131 is a side elevational view of the linking rod of FIG. 129.

FIG. 132 is an alternate perspective view of the first embodiment of a heavy-duty slam-to-close latch in accordance with the present invention.

FIG. 133 is a top plan view of the first embodiment of the heavy-duty slam-to-close latch of FIG. 132.

FIG. 134 is a front elevational view of the first embodiment of the heavy-duty slam-to-close latch of FIG. 132.

FIG. 135 is a side elevational view of the first embodiment of the heavy-duty slam-to-close latch of FIG. 132.

FIG. 136 is a perspective view of a first torsional spring in accordance with the present invention.

FIG. 137 is a perspective view of a second torsional spring in accordance with the present invention.

FIG. 138 is a perspective view of a fourth embodiment of a heavy-duty slam-to-close rotary ratchet pull latch in accordance with the present invention.

FIG. 139 is a left side elevational view of the rotary ratchet pull latch of FIG. 138.

FIG. 140 is a right side elevational view of the rotary ratchet pull latch of FIG. 138.

FIG. 141 is a bottom plan view of the rotary ratchet pull latch of FIG. 138.

FIG. 142 is a rear elevational view of the rotary ratchet pull latch of FIG. 138.

FIG. 143 is a top plan view of the rotary ratchet pull latch of FIG. 138.

FIG. 144 is a front elevational view of the rotary ratchet pull latch of FIG. 138.

FIG. 145 is a perspective view of the latch base of FIG. 138.

FIG. 146 is a top plan view of the latch base of FIG. 145.

FIG. 147 is a rear elevational view of the latch base of FIG. 145.

FIG. 148 is a left side elevational view of the latch base of FIG. 145.

FIG. 149 is a front elevational view of the latch base of FIG. 145.

FIG. 150 is a right side elevational view of the latch base of FIG. 145.

FIG. 151 is a bottom plan view of the latch base of FIG. 145.

FIG. 152 is a perspective view of the handle of FIG. 138.

FIG. 153 is a front elevational view of the handle of FIG. 152.

FIG. 154 is a right side elevational view of the handle of FIG. 152.

FIG. 155 is a rear elevational view of the handle of FIG. 152.

FIG. 156 is a top plan view of the handle of FIG. 152.

FIG. 157 is a bottom plan view of the handle of FIG. 152.

FIG. 158 is a perspective view of the rotary lock plate of FIG. 138.

FIG. 159 is a top plan view of the rotary lock plate of FIG. 158.

FIG. 160 is a front elevational view of the rotary lock plate of FIG. 158.

FIG. 161 is a left side elevational view of the rotary lock plate of FIG. 158.

FIG. 162 is a perspective view of the pawl of FIG. 138.

FIG. 163 is right side elevational view of the pawl of FIG. 162 in its fixed position.

FIG. 164 is a left side elevational view of the pawl of FIG. 162 in its ¼ turn position.

FIG. 165 is front elevational view of the pawl of FIG. 162.

FIG. 166 is a right side elevational view of the pawl of FIG. 162 in its ¼ turn position.

FIG. 167 is a rear elevational view of the pawl of FIG. 162.

FIG. 168 is a right elevational view of the pawl of FIG. 162 in its ¾ turn position.

FIG. 169 is a perspective view of the rivet of FIG. 138.

FIG. 170 is a top plan view of the rivet of FIG. 169.

FIG. 171 is a side elevational view of the rivet of FIG. 169.

FIG. 172 is a perspective view of the torsion spring of FIG. 139.

FIG. 173 is a perspective view of the sliding lock member according to the present invention.

FIG. 174 is a front elevational view of the sliding lock member of FIG. 173.

FIG. 175 is a left side elevational view of the sliding lock member of FIG. 173.

FIG. 176 is a top plan view of the sliding lock member of FIG. 173.

FIG. 177 is a right side elevational view of the sliding lock member of FIG. 173.

FIG. 178 is a rear elevational view of the sliding lock member of FIG. 173.

FIG. 179 is a bottom plan view of the sliding lock member of FIG. 173.

FIG. 180 is a perspective view of the pin of FIG. 139.

FIG. 181 is a side elevational view of the pin of FIG. 180.

FIG. 182 is a bottom plan view of the pin of FIG. 180.

FIG. 183 is a perspective view of the lock plug of FIG. 138.

FIG. 184 is a top plan view of the lock plug of FIG. 183.

FIG. 185 is a left side elevational view of the lock plug of FIG. 183.

FIG. 186 is rear elevational view of the lock plug of FIG. 183.

FIG. 187 is a right side elevational view of the lock plug of FIG. 183.

FIG. 188 is a bottom plan view of the lock plug of FIG. 183.

### DETAILED DESCRIPTION OF THE PREFERRED EMBODIMENTS

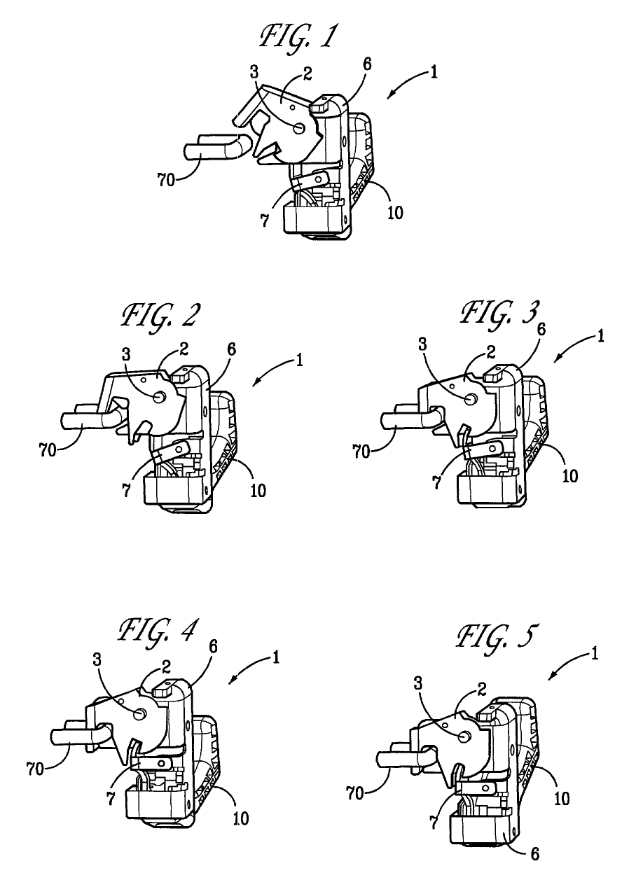

FIGS. 1-5 and FIGS. 132-135 show the first embodiment of the heavy-duty slam-to-close latch 1. Specifically, FIGS. 1-5 and FIGS. 132-135 show a perspective view of the latch 1. FIGS. 1-5 show the latch 1 in various degrees of actuation, beginning with an open or unlocked latch 1 shown in FIG. 1, to a fully engaged locked latch 1 shown in FIG. 5, with the intermediate degrees of actuation shown in FIGS. 2-4.

The latch 1 comprises individual parts, each of which is separately constructed. The latch is comprised of: a pawl 2, a pawl rivet 3, a lock plate rivet 4, a handle pin 5, a latch frame 6, a lock plate 7, a sliding lock member 8, a lock plug 9, a handle 10, a pawl spring 12, and a lock plate spring 13. The spring-loaded pawl 2 is held in the closed position by a spring loaded lock plate 13. Pulling on a handle 10, which contains the sliding lock member 8, and the lock plug 9, opens the latch 1. As the handle 10 rotates, the sliding lock member 8 rotates the lock plate 13 from in between the pawl 2. The sliding lock member 8 in the locked position cannot engage the lock plate 13 when the handle 10 is rotated. Therefore, the latch 1 cannot be opened using the handle 10.

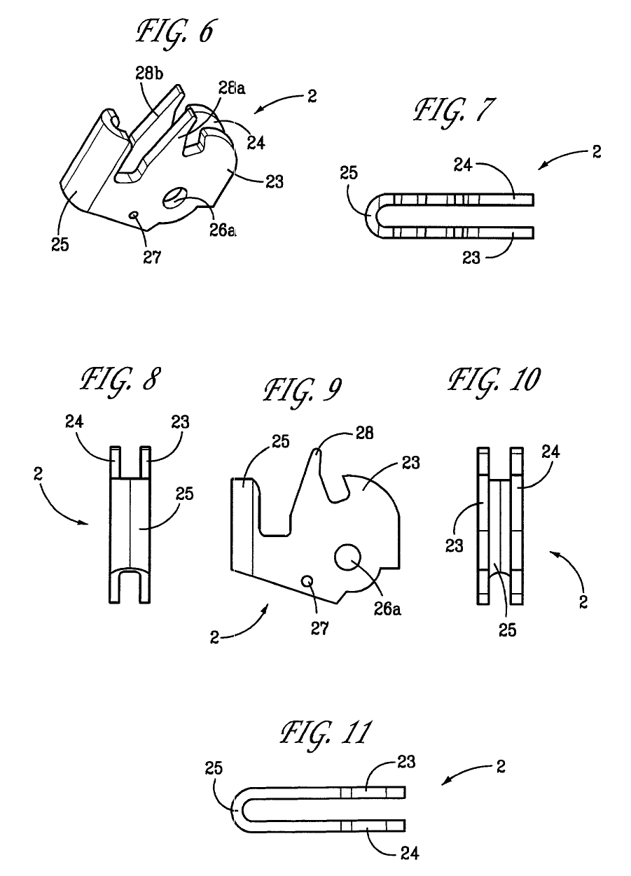

In FIGS. 1-5 and FIGS. 132-135, the main parts are easily seen. Namely, the handle 10 is fixably connected to the latch base 6, which is rotatably connected to the pawl 2 by a pawl rivet 3. FIGS. 6 through 11 all show various perspectives of the pawl 2. The pawl 2, which is a double-sided pawl 2, comprises a first side 23 and a second side 24, which are connected by a generally curved elbow 25. The pawl 2 further comprises a spring hole 27, a locking member 28a and a rivet hole 26a located on the first side 23, and a locking member 28b and a rivet hole 26b (not shown) located on the second side 24. The locking member 28a, 28b allow for the pawl 2 to secure the handle 10 into its locked position

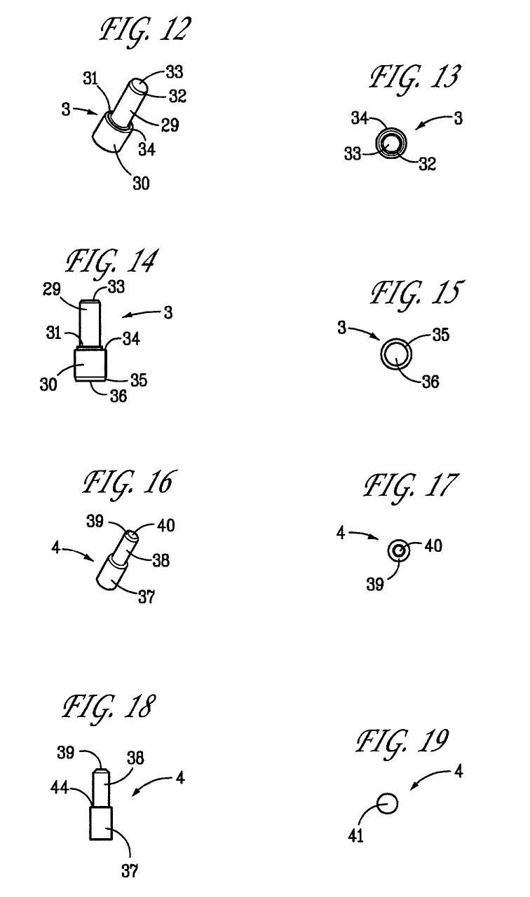

FIGS. 12 through 15 show the pawl rivet 3. The pawl rivet 3 is secured in the rivet hole 26a, and extends through rivet hole 26b of the pawl 2. The pawl rivet 3 comprises a bottom wall 36, which generally slopes to a sloped portion 35, which connects to a first elongated cylindrical portion 30, which comprises an outer top wall 34, which generally slopes to a sloped portion 31, which connects to a second elongated cylindrical portion 29, which terminates at an upper sloped wall 32, which terminates at an upper wall 33. The pawl rivet 3 allows for securing the pawl spring 12 to the pawl 2. The first elongated portion 30 is circumferentially larger than the second elongated portion 29. The first elongated portion 30 is sized to allow for ease of maneuverability and is sized to allow full accommodation of the pawl spring 12. The overall length of the pawl rivet 3 is dimensioned such that it protrudes from the outside of either side of pawl 2 (first side 23 and second side 24).

FIGS. 16 through 19 show the lock plate rivet 4. The lock plate rivet 4 is secured in the lock plate rivet hole 42 of the lock plate 7, and extends through lock plate rivet hole 43 of the latch frame 6. The lock plate rivet 4 allows the lock plate 7 to rotatably mount to the latch frame 6, such that the lock plate rivet hole 42 of the lock plate 7, and the lock plate rivet hole 43 of the latch frame 6 align to accommodate the lock plate rivet 4. The lock plate rivet 4 comprises a bottom wall 41, which connects to a first elongated cylindrical portion 37, which comprises an outer top wall 44, which connects to a second elongated cylindrical portion 38, which terminates at an upper-sloped wall 39, which terminates at an upper wall 40. The lock plate rivet 4 allows for securing the lock plate spring 13 to the lock plate 7 at groove 45. The first elongated portion 37 is circumferentially larger than the second elongated portion 38. The first elongated portion 37 is sized to allow for ease of maneuverability and is sized to allow fill accommodation of the lock plate spring 13.

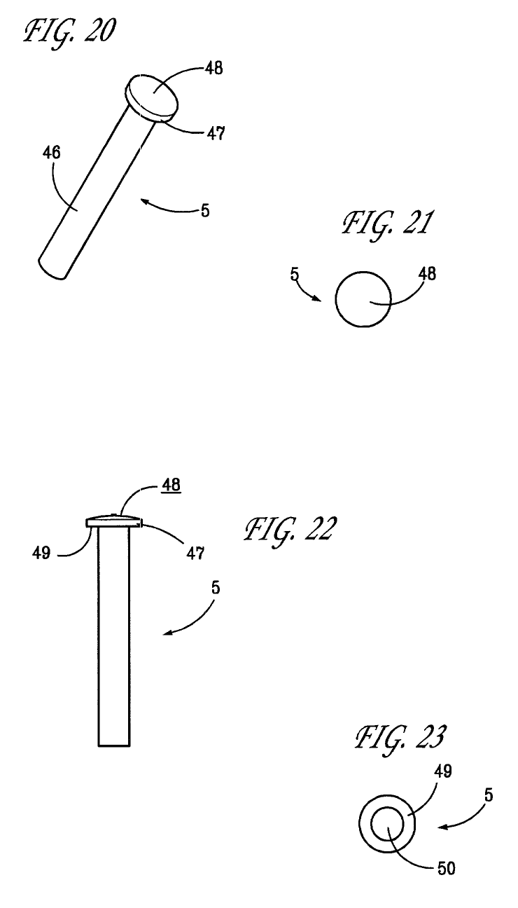

The handle pin 5 is shown in FIGS. 20-23. The handle pin 5 comprises an elongated shaft portion 46, a cap portion 47, a generally curved cap top 48, a cap wall 49, and a bottom pin wall 50. The shaft portion 46 is circumferentially smaller than the cap portion 47, and is much longer to allow engagement of the handle 5 with the latch frame 6. The handle pin 5 extends through handle pinhole 51 and 52 of the latch frame 6, and through handle pinhole 53 of the handle 10, such that, the handle pinhole 51 of the latch frame 6 aligns with the handle pinhole 53 of the handle 10, which aligns with the handle pinhole 52 of the latch frame 6. Thus, the handle pin 5 pivotally mounts the handle 10 with the latch frame 6.

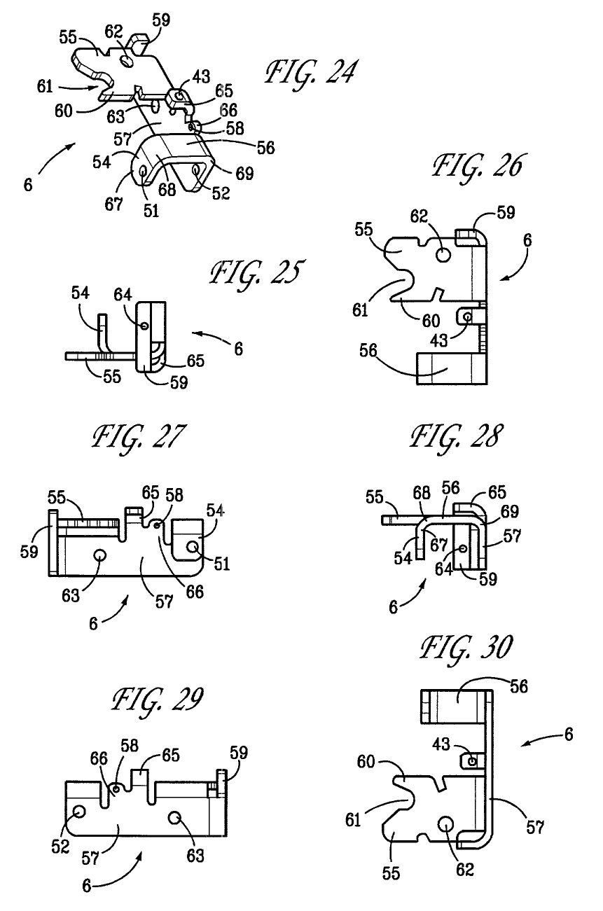

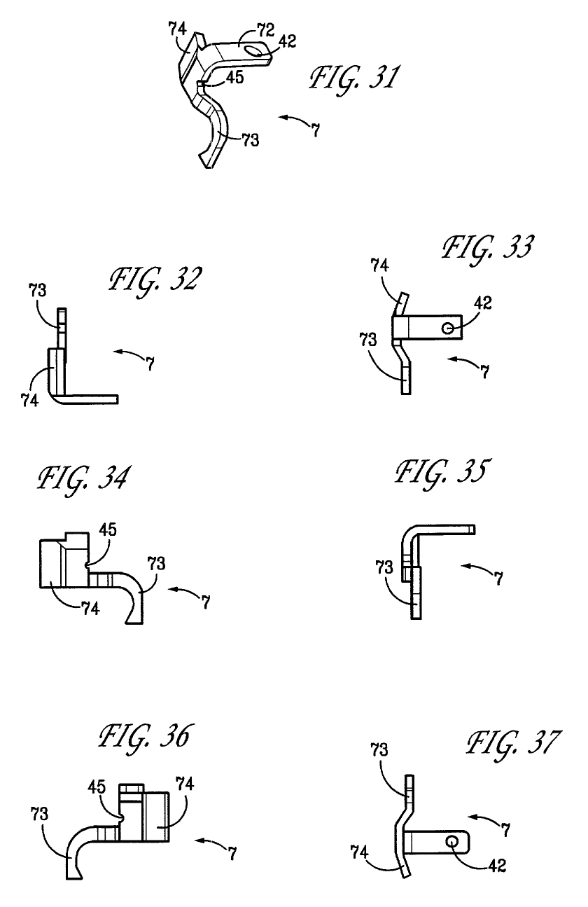

FIGS. 24 through 30 show the full embodiment of the latch frame 6. The latch frame 6 comprises a side portion member 54, a cross member 56, a locking member 55, and a back portion member 57, which are all fixably attached to one another. The side portion member 54 is generally elbow shaped with one elongated portion 67 and a curved portion 68. The curved portion 68 connects to the cross member 56, which connects to another curved portion 69, which is rigidly connected to the back portion member 57. The locking member 55 further comprises a catch 60, an indent 61, and a pawl rivet hole 62. The catch 60 engages a keeper 70 in the indent 61 when the latch 1 is actuated. The latch frame 6 further comprises a side wall 59, which comprises hole 64. The back portion member 57 comprises a back hole 63, a bulbous portion 66 further comprising a lock plate spring hole 58 to accommodate a first end 71 of the lock plate spring 13. The back portion member 57 further comprises an elbow member 65, which comprises the lock plate rivet hole 43.

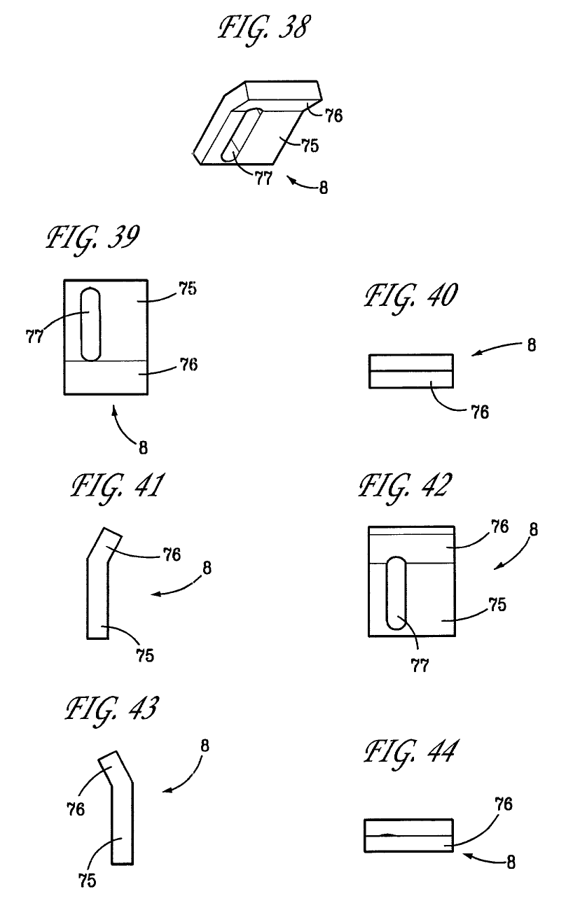

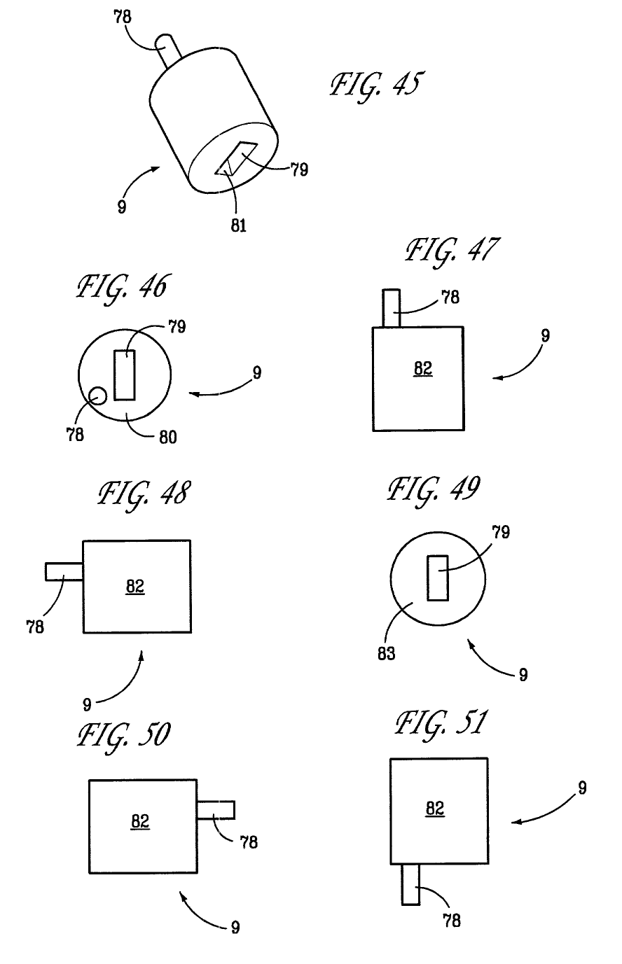

FIGS. 31 through 37 further illustrate the lock plate 7. The lock plate 7 comprises a curved bracket 73, a catch 74, a groove 45, and a support bracket 72. The support bracket 72 further comprises the lock plate rivet hole 42. FIGS. 38 through 44 show the sliding lock member 8. The sliding lock member 8 comprises a straight wall 75, an angled wall 76, and a slot 77. The sliding lock member 8 allows for the engagement and disengagement of the pawl 2 with the lock plate 7.

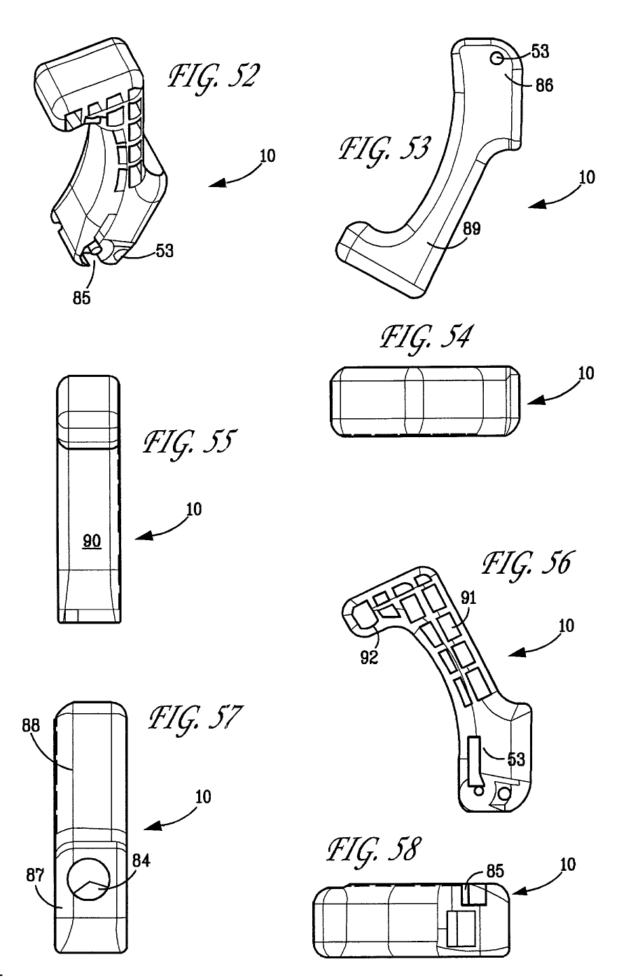

FIGS. 45 through 51 show perspectives of the lock plug 9. The lock plug 9 comprises a peg member 78, a lock plug hole 79, an inner wall 81, a top wall 80, a bottom wall 83, and an outer wall 82. The lock plug allows for locking and unlocking of the pawl 2 with the corresponding movement of the handle 10.

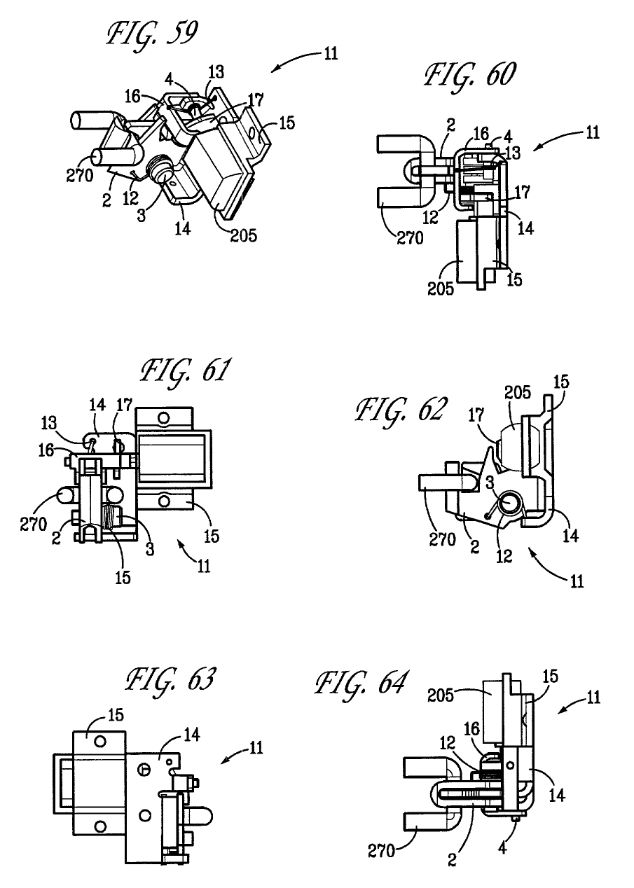

The handle 10 is seen in FIGS. 52 through 58. The handle 10 comprises a locking bore 84 for accommodating the lock plug 9, and to allow for locking and unlocking of the latch 1. The handle 10 further comprises an indent 85, a generally curvilinear member a top wall 87 and a handle top wall 88. The gripping portion 89 on the handle 10 allows for better gripping of the handle and better maneuverability by the user. The handle 10 further comprises a bottom wall 90, a series of gripping handle holes 91 and a bulbous portion 92 both which ease in the operation of the handle and allow for a better grip of the handle by the user. The handle 44 further comprises a handle pinhole 53 for attaching to the latch frame 6.

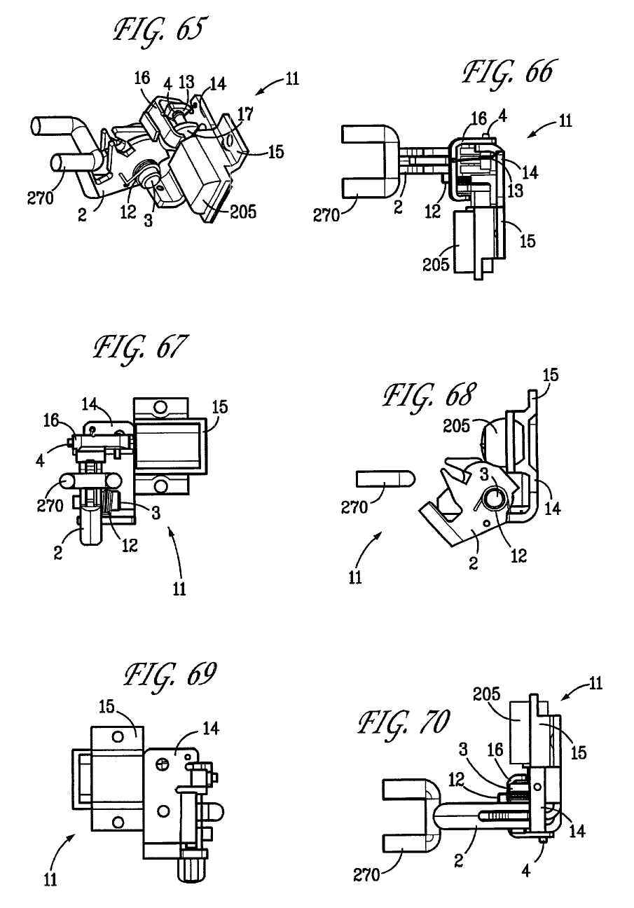

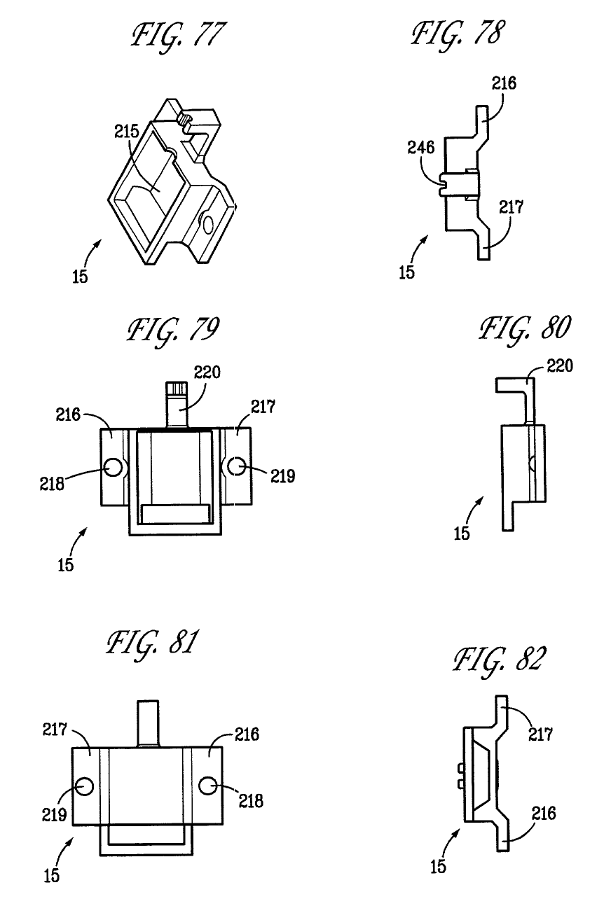

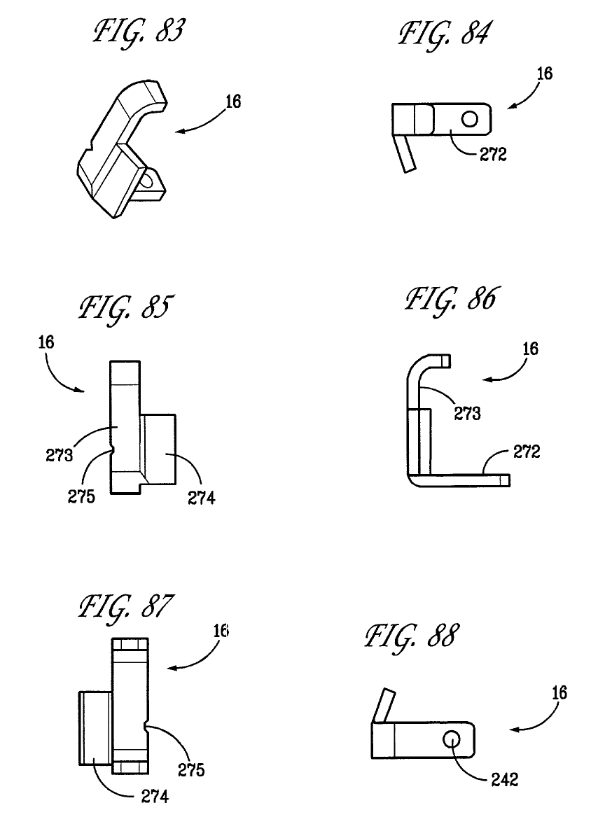

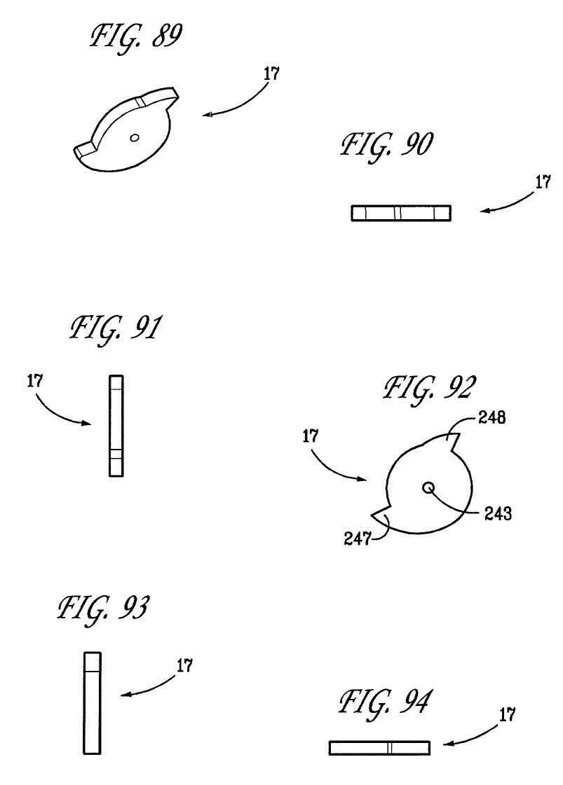

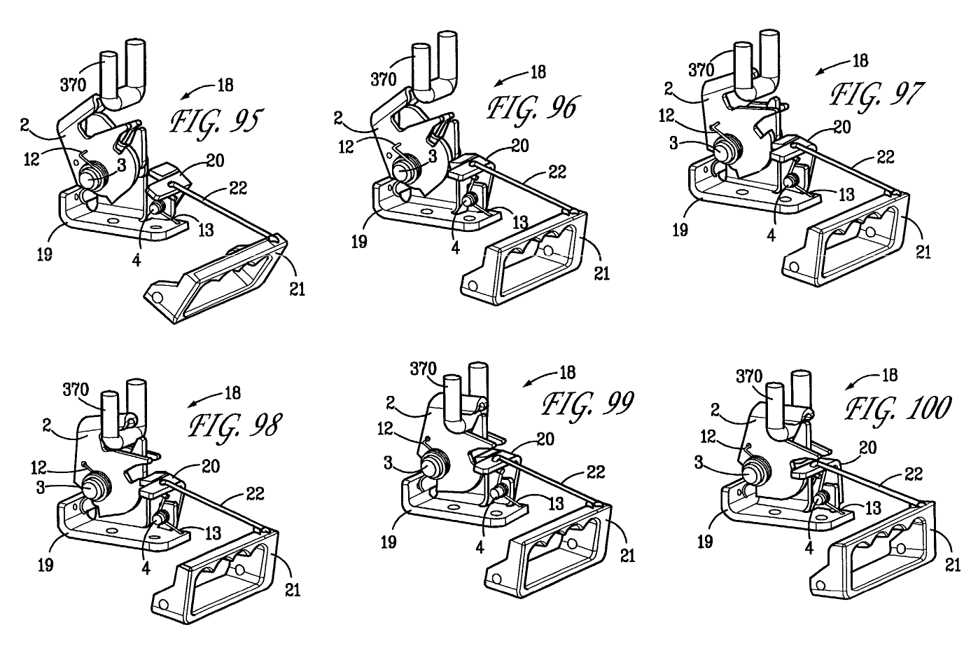

It will be seen that FIGS. 59 through 94 illustrate the second embodiment of the present invention, where such second embodiment is a latch 11, which includes a latch frame 14, a motor housing 15, a motor housing cover 205, a lock plate 16, and a cam 17. The latch 11 of the second embodiment works in the same manner as the latch 1 of the first embodiment, except a motor (not shown) drives the actuation rather than a handle. FIGS. 59 through 64 show the latch 11 in the locked position, with a keeper 270 latched.

FIGS. 65 through 70 show the latch 11 in the unlocked position, with the keeper 270 unlatched. The latch frame 14 of the second embodiment is structurally similar to the latch frame 6 of the first embodiment, except latch frame 14 does not include a side portion member 54 or a cross member 56 or any of the sub components associated with said members 54, 56, which the latch frame 6 comprises. FIGS. 77 through 82 show various perspectives of the motor housing 15, wherein said housing 15 further comprises a receptacle 215, which houses a motor (not shown). A pair of attachment flanges 216, 217 extends from the housing 15, one on each side. The flanges 216, 217 further comprise a pair of holes 218, 219, respectively to allow for attachment means to secure said housing 15 to another member (not shown). Furthermore, an L-shaped bracket 220 extends from said housing 15, wherein said bracket 220 comprises drive shaft securing means 246, which allows a drive shaft (not shown) extending from the motor (not shown) to rest on the bracket 220, and attach to the cam 17.

FIGS. 83 through 88 show the lock plate 16. The lock plate 16 comprises a curved bracket 273, a catch 274, a groove 245, and a support bracket 272. The support bracket 272 further comprises a lock plate rivet hole 242, which accepts a rivet 4, and allows for rotatable movement of said lock plate 16.

FIGS. 89 through 94 show the cam 17, which comprises a drive shaft hole 243 centrally located on the cam 17, which allows for connection of the drive shaft (not shown) to the cam 17. The cam 17 further comprises a pair of wings 247, 248, which, when the cam 17 is rotated by the drive shaft, pushes the lock plate 17 from a locked to unlocked position, thereby releasing the pawl 2.

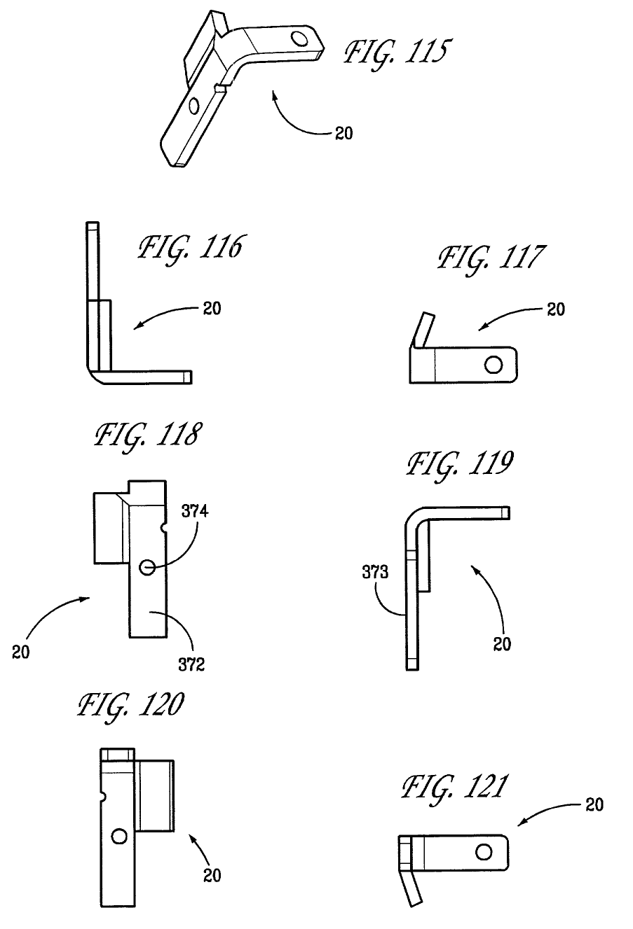

It will also be seen that FIGS. 95 through 131 illustrate the third embodiment of the present invention, where such third embodiment is a latch 18, which includes a latch frame 19, a lock plate 20, and handle 21, and a linking rod 22.

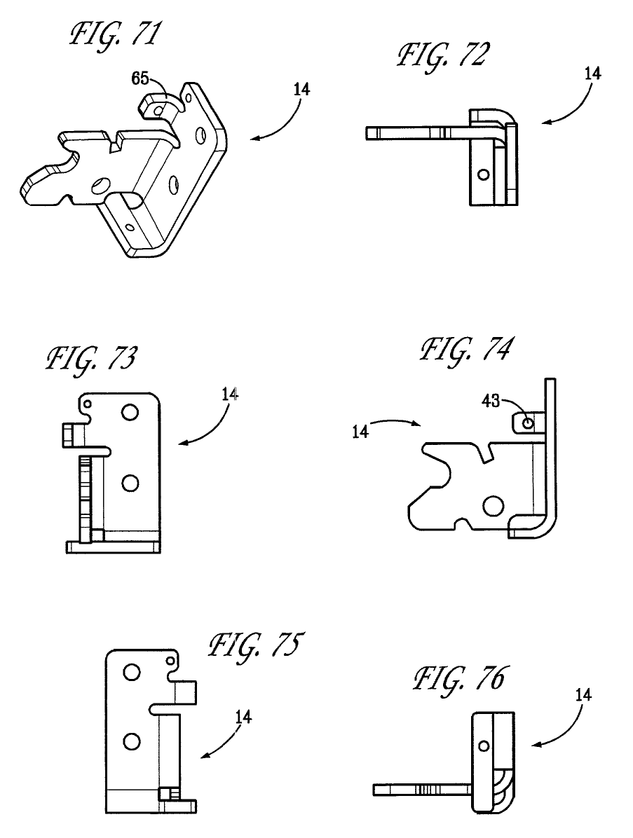

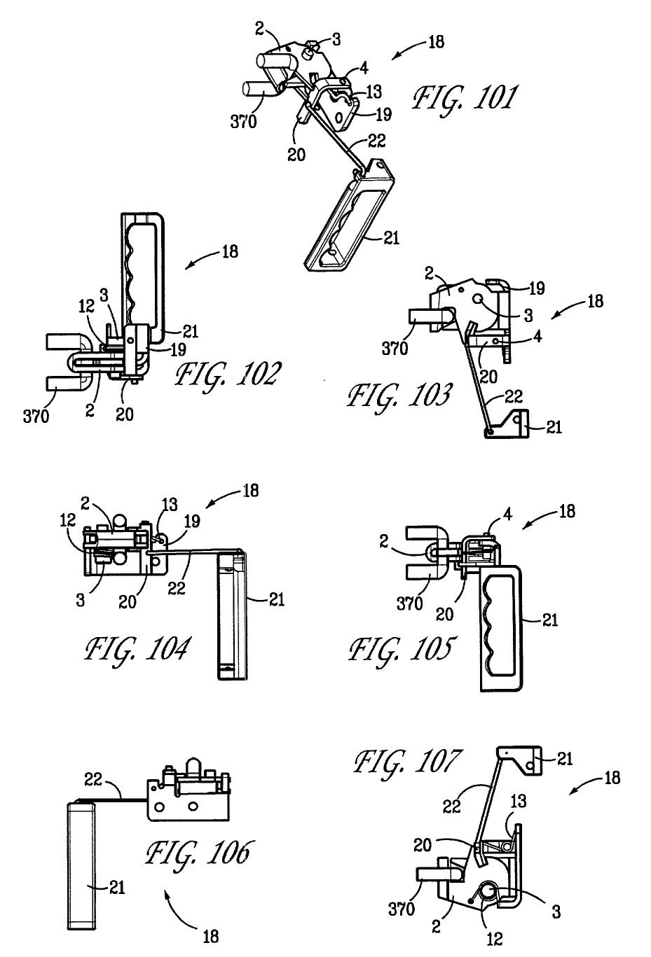

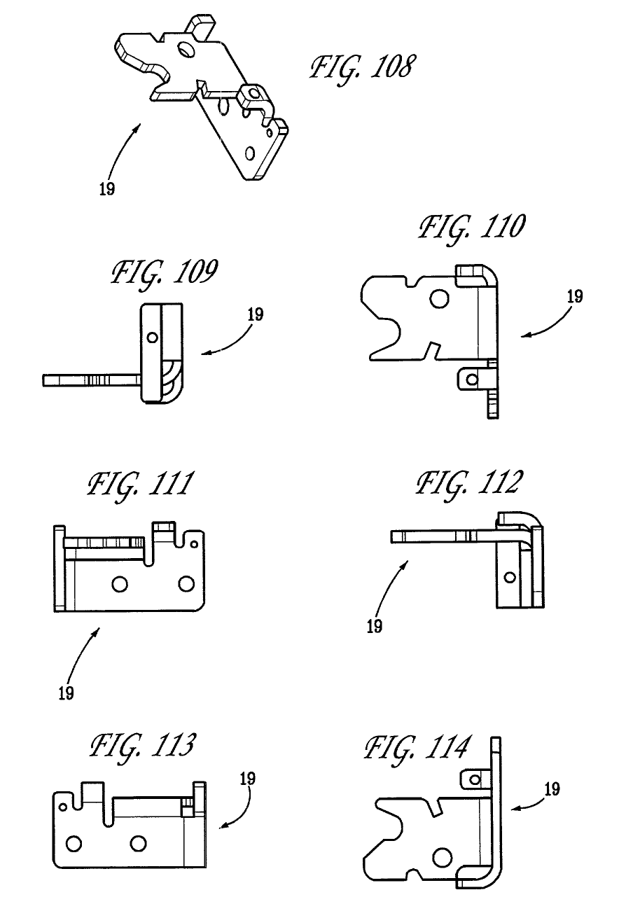

The latch 18 is shown in various stages of actuation in FIGS. 95 through 100, from unlatched to latched. FIGS. 101 through 107 further illustrate the latch 18, whereby the latch 18 is shown latched to a keeper 370. The latch base 19 shown in FIGS. 108 through 114 is structurally identical to the latch base 14 shown in FIGS. 71 through 76.

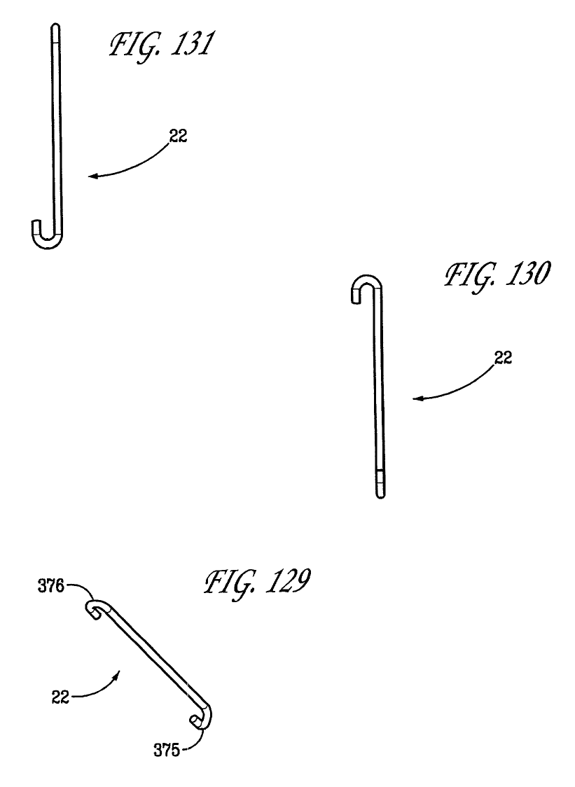

FIGS. 115 through 121 show the lock plate 20, which is structurally similar to the lock plate 16 of FIGS. 83 through 88, with the exception that the bracket 373 of lock plate 20 is straight and not curved like the bracket 273 of lock plate 16. Also, lock plate 20 further comprises a rod hole 374 located on support bracket 372, wherein said rod hole 374 accepts rod end 375 of rod 22, further shown in FIGS. 129 through 131.

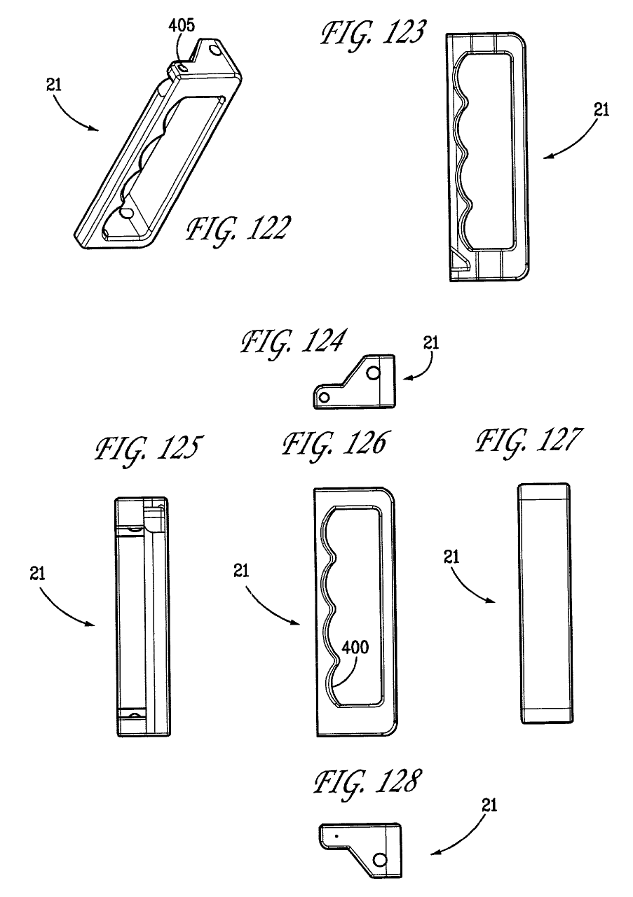

The handle 21 illustrated in FIGS. 122 through 128 comprises gripping means 400 to allow the user to properly grip and actuate the handle 21. The handle 21 further comprises a rod hole 405, which accepts rod end 376 of rod 22, further shown in FIGS. 129 through 131. When the handle 21 is actuated, the rod 22 pulls the lock plate 20, which articulates the lock plate 20 from a locked to unlocked position, thereby releasing the pawl 2.

FIGS. 138 through 144 show a fourth embodiment of the heavy-duty slam-to-close latch, embodied as a tonneau cover latch (rotary ratchet pull latch) 193. Specifically, FIG. 138 shows a perspective view of the rotary ratchet pull latch 193. The latch comprises eleven main parts, each of which is separately constructed. The latch operates in the following manner: a spring-loaded pawl 101 is held in the closed position by a spring loaded lock plate 139. Pulling on a handle 144, which contains a sliding lock member 113, opens the latch 193. As the handle 144 rotates, the sliding lock member 113 rotates the lock plate 139 from under the pawl 101. Once the lock plate interference 203 is removed, the pawl 101 is free to rotate and release the striker or wire form. The lock plate 139 will remain disengaged until the wire is used to rotate the pawl 101 back to the closed position. Rotating the lock plug 189 locks the latch 193. The cam 133 on the back of the lock plug 189 slides the sliding lock member 113 away from the lock plate 139. The sliding lock member 113 in the locked position cannot engage the lock plate 139 when the handle 144 is rotated. Therefore, the latch 193 cannot be opened using the handle 144. A decorative cover (not shown) needs to be mounted over the latch assembly to complete cover security.

In FIG. 138, several main parts are easily seen. Namely, a handle 144 is rotatably connected to a latch base 170, which is rotatably connected to a pawl 101. FIG. 139 shows a left side elevational view of the rotary ratchet pull latch 193 of FIG. 138. In this view, the handle 144 is once again shown rotatably connected to the latch base 170, with the side profile of the pawl 101 also shown.

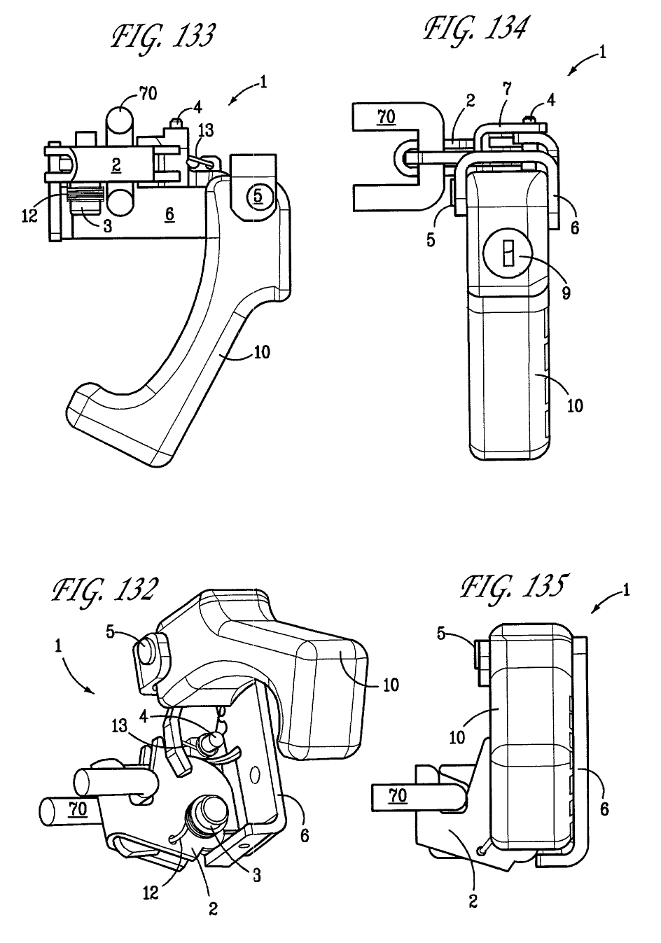

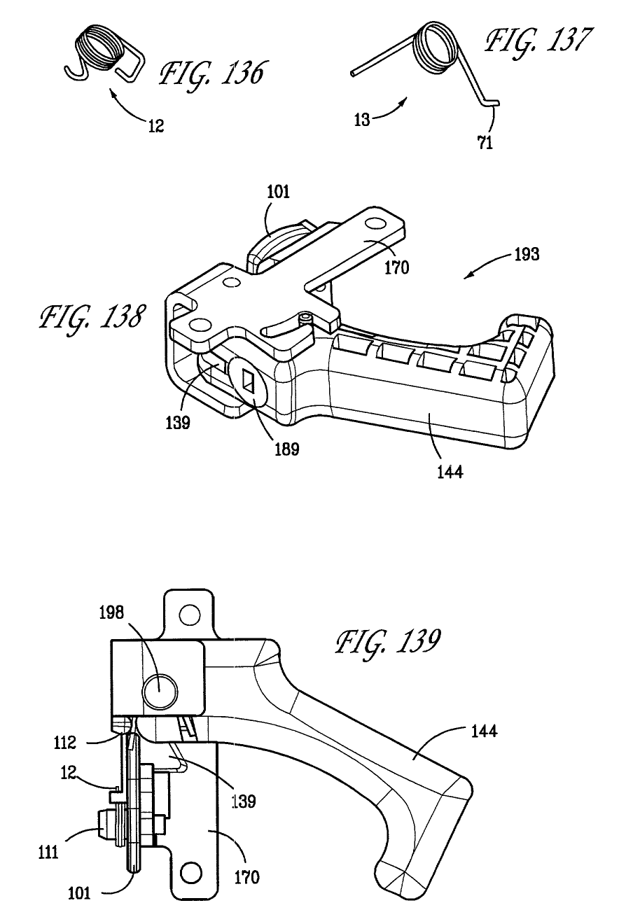

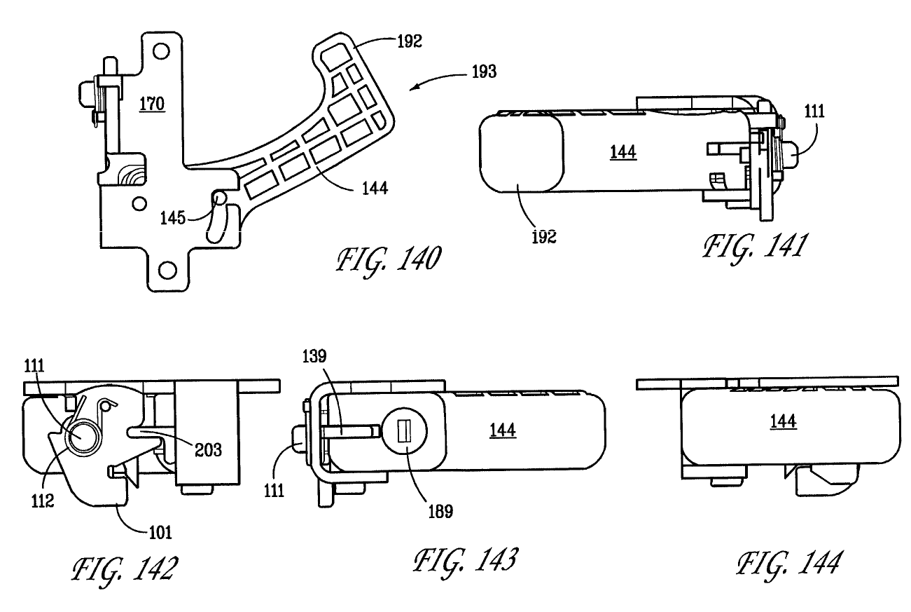

FIG. 13 shows a right side elevational view of the rotary ratchet pull latch 193 of FIG. 138. The left side of the latch base 170 is shown together with a slidably mounted spoke 145, which allows the handle to rotate relative to a fixed latch base. Also, a bulbous portion 192 of the handle 144 is shown. FIG. 141 shows a bottom plan view of the rotary ratchet pull latch 193 of FIG. 138 in which the bulbous portion 192 of the handle 144 is shown from the bottom view.

FIG. 142 shows a rear elevational view of the rotary ratchet pull latch 193 of FIG. 138, where the embodiment of the pawl 101 is shown together with the tensionally attached torsion spring 112. FIG. 143 shows a top plan view of the rotary ratchet pull latch 193 of FIG. 138 with the handle 144 including the lock plug 189. FIG. 144 shows a front elevational view of the rotary ratchet pull latch 193 of FIG. 138 with yet another view of the handle 144.

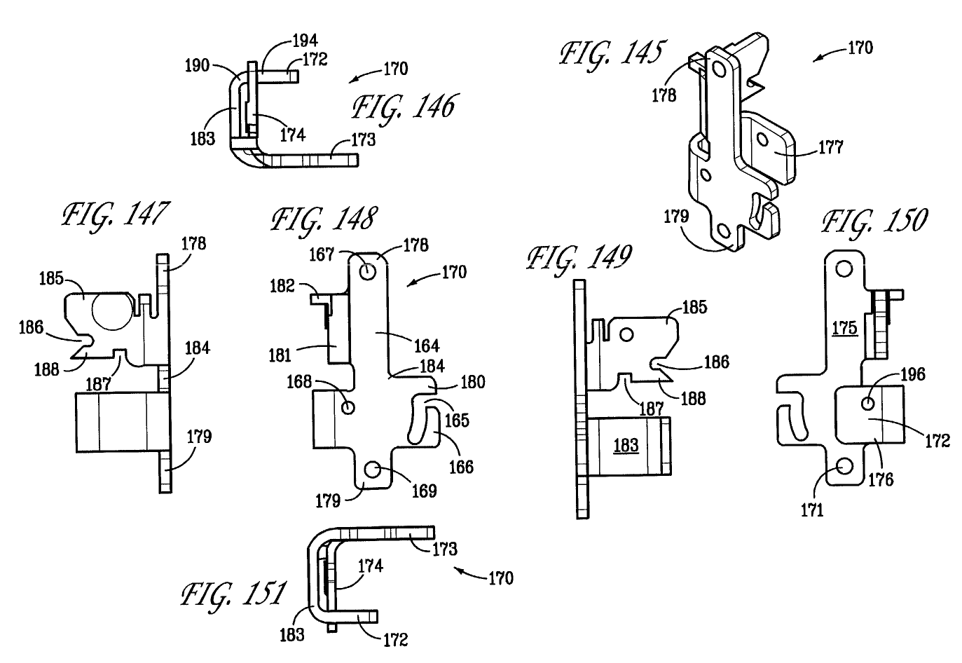

FIGS. 145 through 151 show the fill embodiment of the latch base 170. FIG. 146 shows a top plan view of the latch base 170. The latch base 170 comprises a support side portion member 172, a cross member 174, a locking member 173, and a support back portion member 183, which are all fixably attached to one another. The support side portion member 172 is generally elbow shaped with one elongated portion 194 and is rigidly connected to a support back portion member 183 and a curved portion 195 therebetween. The support side portion member 172 includes an inner wall 177 as is best seen in FIG. 145, and an outer wall 176 as is best seen in FIG. 150. The rear of the latch base, as shown in FIG. 150, shows alternate views of the support back portion member 183 along with the locking member 173, which comprises a top portion 178, a middle portion 184, and a bottom portion 179. Furthermore, a connecting member 185 is shown which comprises a connecting indent 186, a connecting groove 187, and an elongated member 188. These embodiments allow for connection to a rotary lock plate 139.

FIG. 148 shows a left side elevational view of the latch base 170 of FIG. 145. The latch base further comprises a plank member 182, a side member 181, a catching member 180, a first member outer wall 164, a handle spoke indent 165, a catch 166, base holes 167, 168, and 169. The base holes 167, 168, and 169 allow for retention means secure the latch base 170 to some other second member, such as an inner truck bed lining. The handle spoke indent 165 allows for the spoke 145 of the handle 144 to slidably mount the latch base within the catching member 180 and the catch 166. The side member 181 is slightly curved to allow for a smoother outer surface, and the plank member 182 allows for attachment to the pawl 101.

FIGS. 149 and 151 show alternate views of the latch base 170 from the front perspective and the bottom perspective, respectively. FIG. 150 shows a right side elevational view of the latch base 170, where the latch base further comprises a first member inner wall 175, and a support side portion member outer wall 176. Furthermore, the support side portion member contains a hole 196 to allow for retaining means to attach for securing the latch base 170 to some other second member, such as an inner truck bed lining.

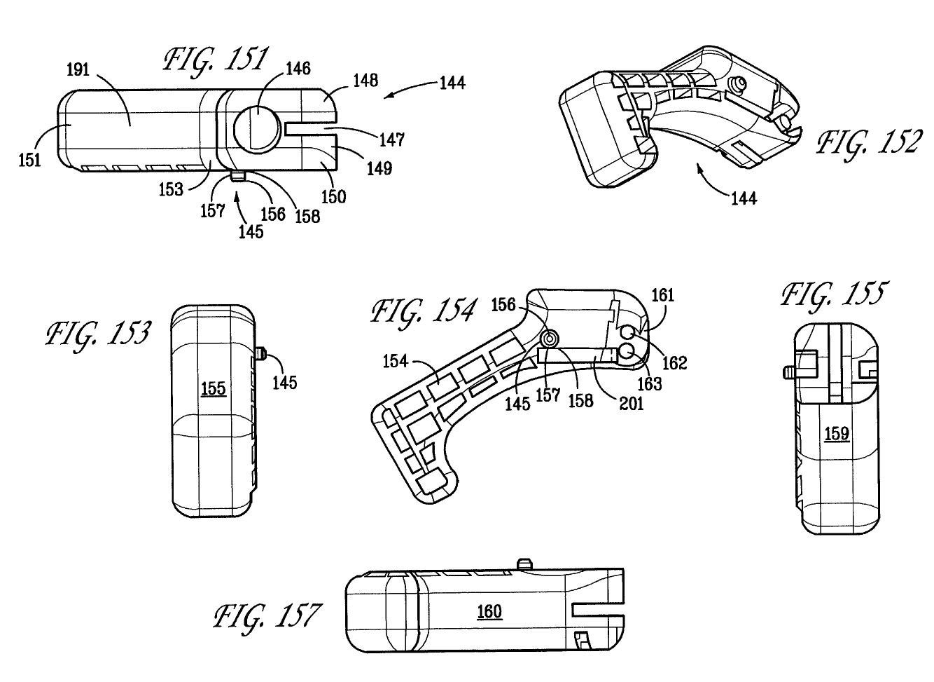

The handle 144 is best seen in FIG. 152 with individual view perspectives given in FIGS. 153 through 157. The handle 144 comprises a locking bore 146 to allow for locking and unlocking of the latch. The handle 144 further comprises an indent 147 acceptance of securing means, a generally curvilinear member 148 and a generally rectangular member 149. The handle 144 has a top wall 150 and a handle top wall 151. The gripping portion 191 on the handle 144 allows for better gripping of the handle and better maneuverability by the user. The handle 144 further comprises a lip 153, and a spoke 145 to rotatably mount to the latch base 170 in the handle spoke indent 165. The spoke 145 comprises a first portion 156, a second portion 157, and a third portion 158.

FIG. 153 further shows the front view perspective of the handle 144 including a handle front wall 155. FIG. 154 details the particulars of the handle 144 including a series of gripping handle holes 154 and the bulbous portion 192 both which ease in the operation of the handle and allow for a better grip of the handle by the user. The handle 144 further comprises an attachment member 161, which includes attachment pegs 162, 163 for attaching to the latch base. FIG. 155 shows the rear view perspective of the handle 144 including a handle back wall 159. FIG. 157 shows a bottom view of the handle 144 including a handle bottom wall 160.

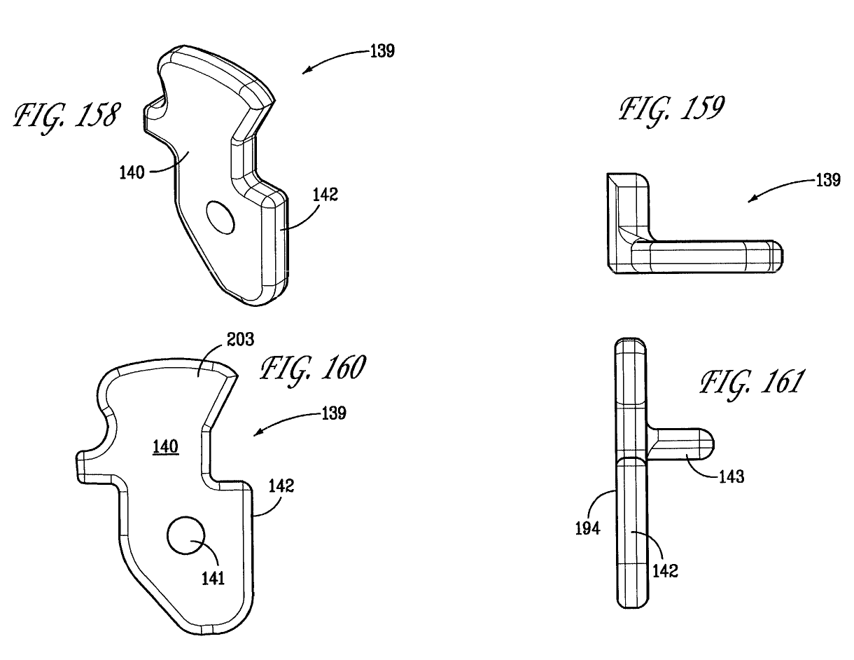

FIGS. 158 through 161 describe the rotary lock plate 139. The rotary lock plate 139 comprises a top surface 140, a bottom surface 194, an outer wall surface 142, a stop 143, and a pinhole 141. The stop 143 provides for keeping the pawl 101 in the closed position until the handle 144 is actuated.

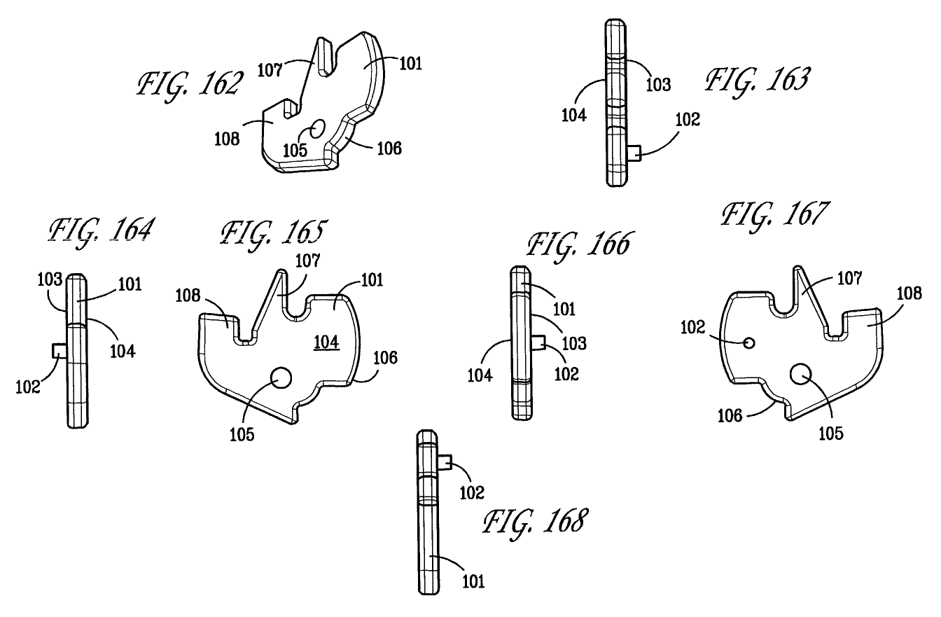

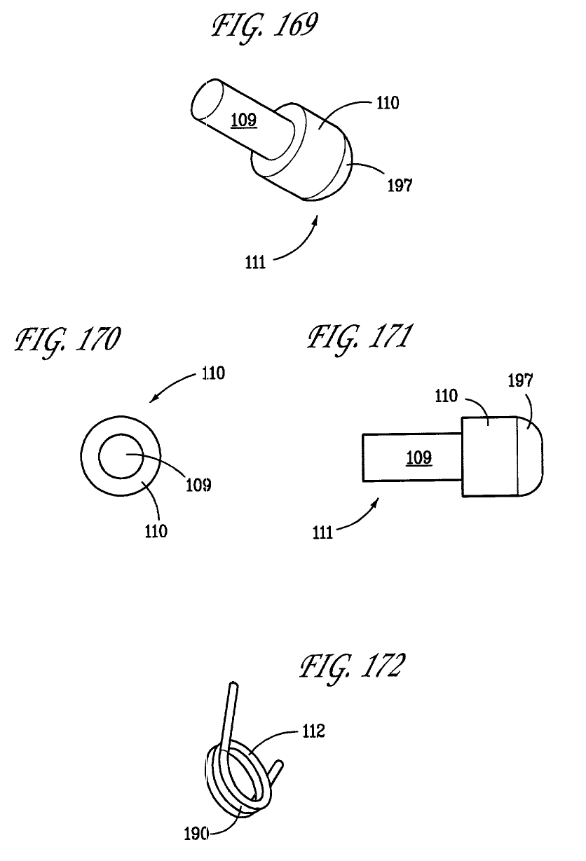

FIGS. 162 through 168 all show various perspectives of the pawl 101. The pawl 101 comprises an upper wall 103, a lower wall 104, a peg 102, an elbow member 108, a locking member 107, an outer wall 106, and a pinhole 105. The locking member 107 allows for the pawl 101 to secure the handle 144 into its locked position. The peg 102 allows for attachment of the torsion spring 112. A rivet 111 is also shown in FIGS. 169 through 171. The rivet 111 comprises an elongated first portion 109, a second portion 110, and an end cap 197. The rivet 111 allows for securing attachment means for the pawl and the lock plate 139 and to the torsion spring 112. The first portion 109 is elongated and is circumferentially smaller than the second portion 110, and the end cap 197. The second portion 110 is sized to allow for ease of maneuverability, and the end cap 197 allows for a rounded end.

FIG. 172 details the torsion spring 112. The torsion spring 112 comprises a series of spring coils 190. The torsion spring 112 allows for the lock plate 139 to engage the pawl 101 when the handle 144 is in the open or closed position. Another torsion spring 112 allows the handle 144 to move from an open or closed position. Yet another torsion spring 112 allows for the lock plate 139 to interlock with the latch base 170 in the closed position. This interlock transfers tensile load on the pawl 101 from the rivet 111 to the latch base 170.

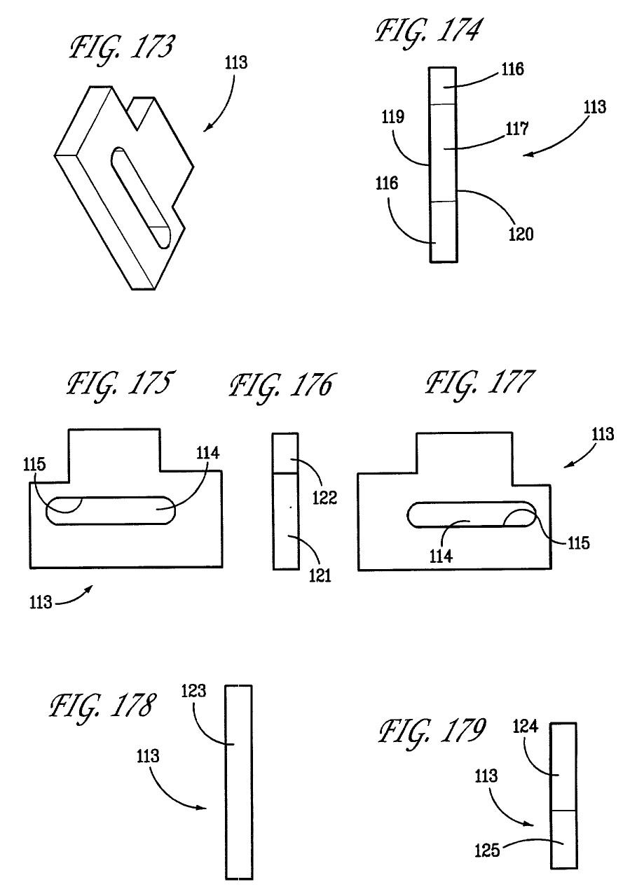

FIGS. 173 through 179 show various perspectives of the sliding lock member 113. The sliding lock member 113 comprises a front upper wall 116, a front middle wall 117, a front lower wall 118, a left wall 119, a right wall 120, and a slot 114. The slot comprises a slot surface 115. The sliding lock member 113 allows for the engagement and disengagement of the pawl 101 with the lock plate 139. The sliding lock member further comprises an upper side top wall 122, an upper side bottom wall 121, a back wall 123, a lower side bottom wall 124, and a lower side top wall 125.

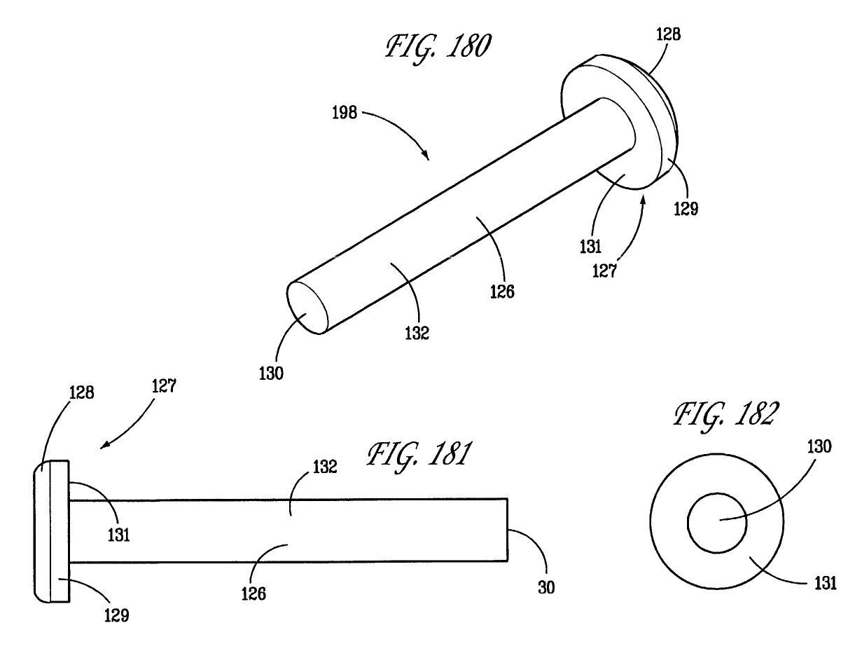

FIGS. 180 through 182 show the pin 198. The pin 198 comprises an elongated shaft portion 126, a cap portion 127, a cap base 129, a base wall 131, a cap top 128, a pin outer wall 132, and a pin bottom wall 130. The shaft portion 126 is circumferentially smaller than the cap base 129, and is much longer to allow engagement of the lock plate 139 with the latch base 170. The pin 198 is used to allow pivot movement of the lock plate 139.

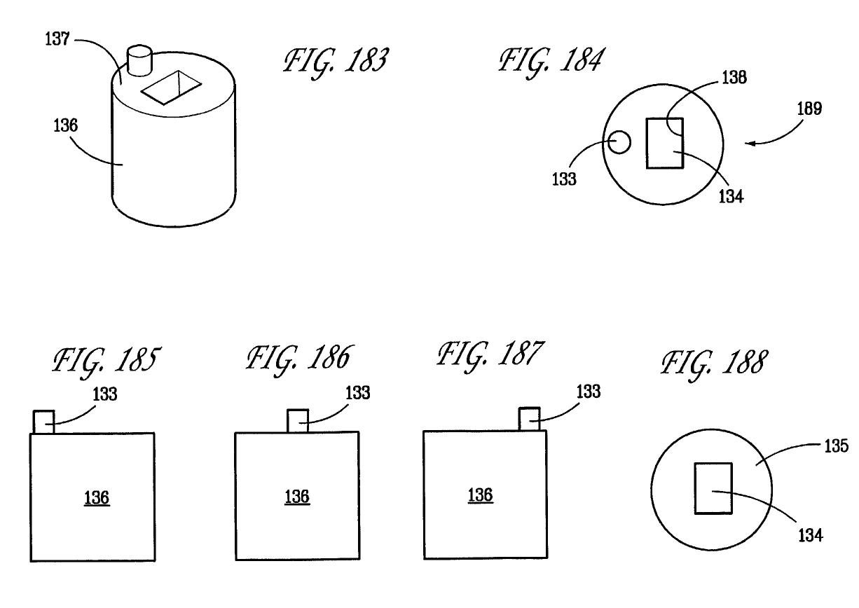

Finally, FIGS. 183 through 188 show perspectives of the lock plug 189. The lock plug 199 comprises a peg member 133, a lock plughole 134, an inner wall 138, a top wall 137, and an outer wall 136. The lock plug allows for locking and unlocking of the pawl 101 with the corresponding movement of the handle 144.

It will be recognized by those skilled in the art that changes may be made by the above-described embodiments of the invention without departing from the broad inventive concept thereof. It is understood, therefore, that this invention is not limited to the particular embodiments disclosed, but it is intended to cover all modifications, which are within the scope and spirit of the invention.

It will be recognized by those skilled in the art that changes may be made by the above-described embodiments of the invention without departing from the broad inventive concept thereof. It is understood, therefore, that this invention is not limited to the particular embodiments disclosed, but it is intended to cover all modifications, which are within the scope and spirit of the invention.

What is claimed is:

1. A latch for securing a first member to a second member, said latch comprising actuation means for opening and closing said latch, a latch base, a lock plate, a pawl, at least one rivet, a plurality of torsion springs, a lock member, a pin, and a lock plug.

2. A latch for securing a first member to a second member, said latch comprising actuation means for opening and closing said latch, a latch base, a lock plate, a pawl, locking means for locking said actuation means; first attachment means for attaching said pawl to said latch base; second attachment means for attaching said lock plate to said latch base; and a plurality of torsion springs.

3. A latch for securing a first member to a second member, said latch comprising:
a. a latch base adapted to receive a handle; said handle adapted to receive a locking member, a pin, a plurality of torsion springs, and a lock plug;
b. a lock plate rotatably connected to a pin; wherein said lock plate further comprises a stop; wherein said stop rests against said latch base;
c. a pawl rotatably connected to said latch base, wherein said pawl is adapted to articulate between a locked and unlocked position.

4. The latch according to claims 1 or 2, wherein said actuation means comprises a handle, wherein said handle is adapted to receive said locking member, a lock plate, a pin, a plurality of torsion springs, and a lock plug.

5. The latch according to claims 1 or 2, wherein said latch base is adapted to receive a handle.

6. The latch according to claims 1 or 2, wherein said lock plate rotatably connects to a pin; wherein said lock plate further comprises a stop; wherein said stop rests against said latch base.

7. The latch according to claims 1 or 2, wherein said pawl rotatably connects to said latch base, wherein said pawl is adapted to articulate between a locked and unlocked position.

8. The latch according to claims 1 or 2, wherein said actuation means comprises a motor-driven cam.

9. The latch according to claim 8, wherein said cam is adapted to articulate said lock plate from an open to a closed position.

10. The latch according to claims 1 or 2, wherein said actuation means comprises a rod-driven handle.

11. The latch according to claim 2, wherein said lock plate is adapted to receive a torsion spring resist.

12. The latch according to claim 10, wherein said lock plate is adapted to receive a rod.

13. The latch according to claim 12, wherein said rod-driven handle is adapted to receive a rod.

14. The latch according to claim 13, wherein said rod connects said rod-driven handle to said lock plate.

15. The latch according to claim 1, wherein said lock plug further comprises a peg, wherein said locking member is adapted to receive said peg.

16. The latch according to claim 2, wherein said locking means for locking said actuation means comprises a lock plug.

17. The latch according to claim 2, wherein said first attachment means for attaching said pawl to said latch base comprises a rivet.

18. The latch according to claim 2, wherein said second attachment means for attaching said lock plate to said latch base comprises a rivet.

19. The latch according to claims 17 or 18, wherein said rivet is adapted to receive a torsion spring.

20. The latch according to claim 1, wherein said rivet is adapted to receive a torsion spring.

21. The latch according to claims 1 or 2, wherein said pawl is adapted to engage said lock plate.

22. The latch according to claims 1 or 2, wherein said pawl is double pronged.

23. The latch according to claims 1 or 2, wherein said pawl is single pronged.

24. The latch according to claims 1 or 2, wherein said latch base is adapted to receive a motor housing.

25. The latch according to claim 24, wherein said motor housing is adapted to house a motor, whereby said motor drives a cam assembly.

26. The latch according to claim 25, wherein said cam assembly is adapted to engage said lock plate, whereby said lock plate articulates in a rotatable direction.

27. The latch according to claims 1 or 2, wherein said latch base is adapted to receive the handle, the pawl, the lock plate, and at least one rivet.
